(19) United States
(12) Patent Application Publication
(10) Pub. No.: US 2025/0279448 A1
(43) Pub. Date: Sep. 4, 2025

(54) FUEL CELL ASSEMBLY WITH EXTERNAL MANIFOLD FOR PARALLEL FLOW

(71) Applicants: EXXONMOBIL TECHNOLOGY AND ENGINEERING COMPANY, Spring, TX (US); FuelCell Energy, Inc., Danbury, CT (US)

(72) Inventors: Keith E. DAVIS, Southbury, CT (US); Lawrence J. NOVACCO, Brookfield, CT (US); Lu HAN, Beaumont, TX (US); Brandon J. O'NEILL, Lebanon, NJ (US); Frank HERSHKOWITZ, Basking Ridge, NJ (US); Rodrigo F. BLANCO GUTIERREZ, Berkeley Heights, NJ (US); Yesim IGCI, Mountainside, NJ (US)

(21) Appl. No.: 19/210,544

(22) Filed: May 16, 2025

Related U.S. Application Data
(63) Continuation of application No. 16/695,362, filed on Nov. 26, 2019, now Pat. No. 12,334,607.

(51) Int. Cl. H01M 8/04276

(52) U.S. Cl. CPC H01M 8/04276

(57) ABSTRACT

A fuel cell is provided including an anode configured to receive, and allow to pass through, an anode process gas, a cathode configured to receive, and allow to pass through, a cathode process gas, and an electrolyte matrix layer separating the anode and the cathode. One of the anode or the cathode has an extended edge seal chamber, and the fuel cell is configured to receive the anode process gas and the cathode process gas in substantially perpendicular directions relative to each other, and the extended edge seal chamber is configured to allow the anode process gas and the cathode process gas to pass through the anode and the cathode in substantially parallel flow paths.

### CROSS-REFERENCE TO RELATED APPLICATIONS

This application is a continuation of U.S. patent application Ser. No. 16/695,362, filed on Nov. 26, 2019, and titled “FUEL CELL ASSEMBLY WITH EXTERNAL MANIFOLD FOR PARALLEL FLOW” the entirety of which is hereby incorporated by reference.

ExxonMobil Research and Engineering Company and FuelCell Energy, Inc. are parties to a joint research agreement.

### BACKGROUND

The present application relates generally to the field of fuel cell assemblies, and more particularly to fuel cell assemblies with external manifolds that provide anode and cathode feed gas flowing in parallel directions.

A conventional fuel cell stack assembly may be formed with a plurality of fuel cells, each with an anode layer and cathode layer separated by an electrolyte layer. The plurality of fuel cells may be arranged to form a stack of fuel cells. Each anode layer includes an anode inlet (i.e., one face of the stack of fuel cells) and an opposing anode outlet (i.e., an opposite face of the stack), and anode feed gas passes through the anode layers from the anode inlet to the anode outlet in a first direction. Similarly, each cathode layer includes a cathode inlet (i.e., another face of the stack) and an opposing cathode outlet (i.e., an opposite face of the stack), and cathode feed gas passes through the cathode layers from the cathode inlet to the cathode outlet in a second direction, which is perpendicular to the first direction. The perpendicular flow of the anode feed gas and the cathode feed gas generates a two-dimensional distribution of current within the fuel cell. For example, the current may be highest in a corner proximate both the anode inlet and the cathode inlet (due to increased gas concentrations) and may be lowest in a corner proximate the anode outlet and the cathode outlet (due to decreased electrochemical activity). The two-dimensional distribution of current then varies in both the first direction and the second direction, making it difficult to optimize the flow of the anode and cathode feed gases to reduce variance in the current across each fuel cell.

The standard perpendicular flow, or cross flow, configuration produces a two-dimensional current across the cell surface, which in turn induces a two-dimensional thermal gradient. This thermal gradient, with one corner colder than the average temperature of the flow field and another corner hotter than the average temperature of the flow field, is problematic when many cells are stacked due to differential thermal expansion. The hot corner/side grows more than the cold corner/side resulting in stack distortion, tilting, and bending because the cells are no longer planar. This distortion can also induce contact loss, and vary the amount of local compression on different areas of the cell. The taller the stack, the more this effect comes into play. It would be advantageous to provide a fuel cell assembly that provides anode feed gas and cathode feed gas flowing in parallel directions in order to provide a one-dimensional distribution of current and, thus, a one-dimensional temperature gradient. If achieved, the cells within the stack will remain substantially planar, resulting in better contact, more predictable movement, and less challenges with maintaining uniform stack compression.

### SUMMARY

In accordance with the present invention, a fuel cell stack is provided including a plurality of fuel cells having an anode and a cathode separated by an electrolyte matrix layer and one of the anode or the cathode has an extended edge seal chamber configured such that during operation when anode process gas and cathode process gas is provided to the fuel cell stack in substantially perpendicular directions relative to each other, those process gases flow in substantially parallel through the fuel cells.

In accordance with one embodiment of the present invention, a fuel cell used in a fuel cell stack is provided wherein the fuel cell has a first layer having an active area configured to receive and output a first process gas, a second layer configured to receive and output a second process gas, and an electrolyte matrix layer separating the first layer and the second layer. The first layer includes an edge seal chamber extending cantilever outboard from the stack face, beyond the active area on two opposite sides of the fuel cell (extended edge seal chamber). The extended edge seal chamber is configured to receive the first process gas provided to the fuel cell stack in a first direction relative to the fuel cell stack and output the first process gas to the active area in a second direction substantially perpendicular to the first direction, and substantially in parallel with the second process gas. The active area is configured to allow the first process gas to react with the second process gas. The two gasses within the active area flow substantially parallel to each other.

In another aspect, the second layer is configured to receive and output the second process gas in a direction substantially parallel to the second direction.

In another aspect, the first layer includes a diverting surface configured to receive the first process gas and divert the first process gas into the extended edge seal chamber.

In accordance with another embodiment of the present invention, a fuel cell used in a fuel cell stack is provided wherein the fuel cell has an anode layer having an active anode area configured to receive and output anode process gas, a cathode layer configured to receive and output cathode process gas, and an electrolyte matrix layer separating the anode layer and the cathode layer. The anode layer includes a first extended edge seal chamber extending away from the active anode area on a first side of the fuel cell. The first extended edge seal chamber is configured to receive anode process gas provided to the fuel cell stack in a first direction relative to the fuel cell stack and output the anode process gas to the active anode area in a second direction substantially perpendicular to the first direction. The anode active area is configured to allow the anode process gas to react with the cathode process gas.

In another aspect, the fuel cell includes a second extended edge seal chamber extending away from the active anode area on a side opposite the first side of the fuel cell. The second extended edge seal chamber is configured to receive the anode process gas in the second direction and divert the anode process gas in the first direction relative to the fuel cell stack.

In another aspect, the cathode layer is configured to receive the cathode process gas in a direction substantially parallel to the second direction.

In another aspect, the cathode layer is configured to output the cathode process gas in a direction substantially parallel to the second direction.

In another aspect, the anode layer includes a first diverting surface configured to receive the anode process gas in the first direction and redirect the anode process gas toward the first extended edge seal chamber.

In another aspect, the anode layer includes a second diverting surface configured to receive the anode process gas from the second extended edge seal chamber and redirect the anode process gas in the first direction.

### BRIEF DESCRIPTION OF THE DRAWINGS

FIG. 1 is a schematic of a fuel cell.

FIG. 2 is a perspective view of a conventional fuel cell stack.

FIG. 3 is a perspective view of a fuel cell stack, according to an exemplary embodiment.

FIG. 4A is a top plan view of a fuel cell assembly, according to an exemplary embodiment.

FIG. 4B is a top plan view of a fuel cell assembly, according to another exemplary embodiment.

FIG. 4C is a top plan view of a cathode level of the fuel cell assembly depicted in FIG. 4A.

FIG. 4D is a top plan view of an anode level of the fuel cell assembly depicted in FIG. 4A.

FIG. 5 shows a distribution of current in a conventional fuel cell assembly with bipolar plates providing a flow of anode feed gas perpendicular to a flow of cathode feed gas.

FIG. 6 shows a distribution of current in a fuel cell assembly with bipolar plates providing a flow of anode feed gas parallel to a flow of cathode feed gas.

### DETAILED DESCRIPTION

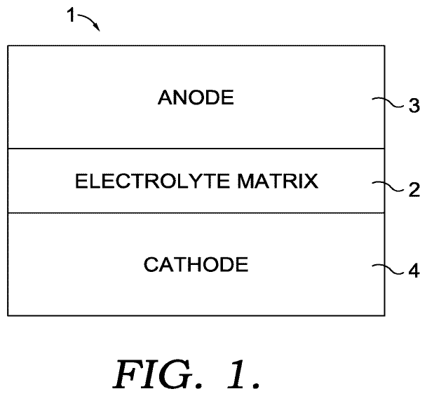

FIG. 1 shows a schematic of a fuel cell 1. The fuel cell 1 comprises an electrolyte matrix 2, and anode 3, and cathode 4. The anode 3 and cathode 4 are separated from one another by the matrix 2. An oxidant (e.g., air or flue gas from a combustion exhaust supply unit) is fed to the cathode 4. Fuel gas (e.g., hydrocarbon gas) is fed to the anode 3. In the fuel cell 1, in the cathode, CO₂ and O₂ in the form of CO₃⁼ ions are transferred from the cathode to the anode, fuel gas and oxidant gas undergo an electrochemical reaction in the presence of an electrolyte (e.g., carbonate electrolyte) present in the pores of the electrolyte matrix 2.

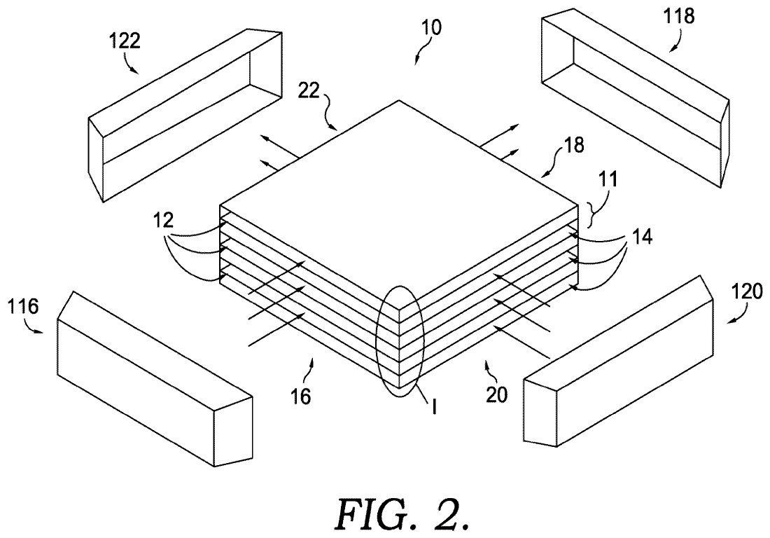

Referring to FIG. 2, a conventional fuel cell stack 10 includes a plurality of fuel cells 11, each having an anode layer 12 (comprising an anode electrode and an anode flow chamber/current collector, not shown) and a cathode layer 14 (comprising a cathode electrode and an cathode flow chamber/current collector, not shown), with the fuel cells stacked one on top of another and so on. The fuel cell stack 10 includes an anode inlet side (or stack face) 16 configured to receive anode feed gas and an opposing anode outlet side (or stack face) 18 configured to output anode exhaust after it has passed through an anode layer 12. The anode feed gas may be provided via an external manifold (anode inlet manifold 116) sealed against the anode inlet stack face 16. For reference purposes, the external manifolds depicted in FIG. 2 have been removed from the fuel cell stack 10. To be clear, during operation, external manifolds (e.g., anode inlet manifold 116) would be sealed against corresponding fuel stack face. The anode exhaust may be received by another external manifold sealed against the anode outlet stack face 18 (anode outlet manifold 118). The fuel cell stack 10 further includes a cathode inlet side (or stack face) 20 configured to receive cathode feed gas and an opposing cathode outlet side (or stack face) 22 configured to output cathode exhaust after it has passed through a cathode layer 14. The cathode feed gas may be provided via an external manifold sealed against the cathode inlet stack face 20 (cathode inlet manifold 120). The cathode exhaust may be received by another external manifold sealed against the cathode outlet stack face 22 (cathode outlet manifold 122). In some embodiments, at least three of the four stack faces may have external manifolds sealed against each stack face. For example, the stack may be housed in sealed housing (e.g., module) and the anode inlet side, the anode outlet side, and the cathode inlet side may be sealed with external manifolds. The cathode outlet side in this example may be open to the sealed housing.

In the fuel cell stack 10 shown in FIG. 2, anode feed gas flows through each anode layer 12 in a substantially linear direction from the anode inlet stack face 16 to the anode outlet stack face 18. (As referenced herein, “substantially linear” means a majority of volume of a gas flows in a certain direction.) Similarly, the cathode feed gas flows through the cathode layer 14 in a substantially linear direction from the cathode inlet stack face 20 to the cathode outlet stack face 22. The anode and cathode feed gases flow substantially perpendicularly to each other (i.e., a majority of volume of anode feed gas flows in a first direction and a majority of volume of cathode feed gas flows in a second direction that is substantially perpendicular to the first direction) when they are within the stack (also known as “cross-flow”). Because of this, the current density may be highest at a corner of the fuel cell stack 10, proximate where the anode inlet side 16 meets the cathode inlet side 20 (region I) and varies non-linearly in the directions of each of the anode feed gas flow and the cathode feed gas flow through the fuel cell assembly 11. It would therefore be advantageous to reorient the flow of the anode feed gas and the cathode feed gas relative to each other within the stack, such that the anode and cathode flows pass through the fuel cell stack 10 in a substantially parallel configuration (also known as “parallel flow”, “co-flow”, or “counter-flow”).

The present invention allows substantially parallel flow of two process gas mixtures within a four-sided fuel cell stack where the two process gas mixtures are supplied and removed from the stack in substantially perpendicular directions from each other. In other words, the present invention allows substantially parallel flow within a fuel cell stack without significantly changing the process gas delivery to and from the fuel cell stack (i.e., with external manifolds) as described in relation to FIG. 2.

Referring now to FIG. 3, the fuel cell stack 200 shows how anode feed gas passes through corners of the fuel cell stack 200 to be redirected substantially parallel to the cathode feed gas and anode exhaust is again redirected to be output substantially perpendicularly to the cathode exhaust. (For ease of reference, arrows designated with “A” represent the flow path for anode process gas and arrows designated with “C” represent the flow path for cathode process gas.) The fuel cell stack 200 includes a plurality of fuel cell assemblies 211, each having an anode layer 208 and a cathode layer 210, with the fuel cells stacked on top of one another and separated from each other by a steal separator sheet (e.g., a bipolar plate). It is noted that the top surface of the top most fuel cell assembly 211 has been removed to show flow paths within that fuel cell assembly. It will be appreciated that save for the porous active area of the anode electrode (anode active area) 213, the anode layer 208 of each fuel cell assembly 211 is otherwise a sealed chamber with a single inlet (partial anode inlet 216, discussed below) and a single outlet (partial anode outlet 218, discussed below). As used herein, “active area” is the area on a fuel cell layer (anode, cathode) that is configured to allow selective diffusion of molecules in a process gas to diffuse there through, i.e., feed gases undergo an electrochemical reaction in the active area. Said another way, the leading and trailing edges of both the anode and cathode of a fuel cell have a narrow non-active area corresponding to a wet seal between adjacent cells above and below the fuel cell. Feed gases pass through the wet seal without undergoing an electrochemical reaction. The rest of the area of the fuel cell, which is overlapping and common to both the anode and cathode layers, is subject to electrochemical activity and is known as the “active area”. Similarly, apart from a porous active cathode electrode (not shown), the cathode layer 210 of each fuel cell assembly 211 is otherwise a sealed chamber with a cathode inlet 226 and a cathode outlet 228. It will be further noted that portions of the side walls of the fuel cell assemblies 211 have been removed to show flow paths through the cathode layer of the top most fuel cell assembly 211 (and flow paths of the anode and cathode layers of the fuel cell assembly 211 directly below the top most fuel cell assembly 211). It will also be further noted that reference may be made to enumerated features corresponding to the top most fuel cell assembly 211, but such enumerated features may be applicable to other fuel cell assemblies 211 included in fuel cell stack 200.

It will be noted that the fuel cell assemblies 211 described herein include an anode layer 208 and a cathode layer 210 separated by an electrolyte matrix layer, and steal separator sheets form the upper surface and lower surface of the fuel cell assembly. However, in other embodiments, a first fuel cell assembly may include an anode layer 208 and a cathode layer 210 separated by a steal separator sheet, and an anode electrode forms a first surface (e.g., upper surface) and a cathode electrode forms a second surface (e.g., lower surface). A single functional fuel cell unit is formed when a second fuel cell assembly (having the same components as the first fuel cell assembly) is stacked on top or below the first fuel cell assembly and the two fuel cell assemblies are separated by an electrolyte matrix layer. In other words, a single fuel cell unit is formed when the cathode of the first fuel cell assembly communicates with an electrolyte matrix, which communicates with the anode of the second fuel cell assembly.

Although FIG. 3 shows three fuel cell assemblies 211, the invention is not so limited and a fuel cell stack may comprise more or less fuel cell assemblies. Each fuel cell assembly 211 includes two extended edge seal chambers 236, 246—a first extended edge seal chamber 236 (e.g., an upstream extended edge seal chamber) on a first side of the fuel cell assembly and a second extended edge seal chamber 246 (e.g., a downstream extended edge seal chamber) on the opposite side of the fuel cell assembly. As depicted in FIG. 3, the extended edge seal chambers extend cantilever outboard from the stack face, beyond the active area on two opposite sides of the fuel cell.

As with the fuel cell stack 10 depicted in FIG. 2, the fuel cell stack 200 (in FIG. 3) includes an anode inlet side (or stack face) 212 and an opposing anode outlet side (or stack face) 214, which is substantially parallel to the anode inlet side 212. However, unlike the anode inlet stack face 16 of fuel cell stack 10, which includes a substantially open face/inlet for anode feed gas to enter each fuel cell, the anode inlet stack face 212 is not so open and each fuel cell assembly 211 includes a first partial seal 212a and a partial anode inlet 216. In an exemplary embodiment, an external manifold is sealed against the anode inlet stack face 212 (not shown) and anode feed gas provided in the external manifold (not shown) enters the anode section of the fuel cell via the partial anode inlet 216. Similarly, unlike the anode outlet stack face 18 of fuel cell stack 10, which includes a substantially open face/outlet (not shown) for anode exhaust to leave each fuel cell, the anode outlet stack face 214 is not so open and each fuel cell assembly 211 includes a second partial seal 214a and a partial anode outlet 218.

During operation of the fuel cell stack 200, each anode layer 208 is configured to receive anode feed gas at the anode inlet side 212 of the fuel cell stack 200 from an anode feed gas supply (i.e., source), for example, via an external manifold (not shown), and to output anode exhaust at the anode outlet side 214 of the fuel cell stack 200, for example, via another external manifold (not shown), after the anode feed gas has been reacted with cathode feed gas in the fuel cell stack 200. Specifically, each anode layer 208 includes a partial anode inlet 216 (i.e., an anode inlet opening) formed in only a portion of the anode inlet side 212, at an upstream portion of the anode layer 208. Each anode layer 208 further includes a partial anode outlet 218 (i.e., an anode outlet opening) formed in only a portion of the anode outlet side 214, at a downstream portion of the anode layer 208.

The fuel cell stack 200 further includes a cathode inlet side (or stack face) 222 and an opposing cathode outlet side (or stack face) 224, which is substantially parallel to the cathode inlet side 222. In some embodiments, the cathode layers 210 are similar in structure to, and similarly operate as, the cathode layers 14 of fuel cell stack 10 depicted in FIG. 2. In other words, in some embodiments, the cathode feed gas may flow through the cathode layer 210 in a substantially linear direction from the cathode inlet stack face 222 to the cathode outlet stack face 224. As depicted in FIG. 3, it will be appreciated that the first extended edge seal chamber 236 (at the anode layer 208) is cantilevered over a cathode inlet 226. Moreover, a plurality of the first extended edge seal chambers 236 forms a series of cantilevered protrusions along the cathode inlet stack face 222. Similarly, a plurality of the second extended edge seal chambers 246 forms a series of cantilevered protrusions along the cathode outlet stack face 224.

During operation of the fuel cell stack 200, each cathode layer 210 is configured to receive cathode feed gas at the cathode inlet side 222 of the fuel cell stack 200 from a cathode feed gas supply (i.e., source), for example, via an external manifold (not shown), and to output cathode exhaust at the cathode outlet side 224 of the fuel cell stack 200, for example, via an external manifold (not shown), after the cathode feed gas has been reacted with anode feed gas in the fuel cell stack 200. Specifically, each cathode layer 210 includes a cathode inlet 226 (i.e., a cathode inlet opening) formed in the cathode inlet side 222, at an upstream portion of the cathode layer 210. Each cathode layer 210 further includes a cathode outlet 228 (i.e., a cathode outlet opening) formed in the cathode outlet side 224, at a downstream portion of the cathode layer 210. According to an exemplary embodiment, the cathode inlet 226 and the cathode outlet 228 may extend substantially an entire width of the cathode layer 210, although according to other exemplary embodiments, the cathode inlet 226 and/or the cathode outlet 228 may extend along only a portion of the width of the cathode layer 210.

As shown in FIG. 3, the anode feed gas is supplied to and the anode exhaust is output from the anode layer 208 along substantially parallel flow paths through the fuel cells and fuel cell stack. For example, the anode feed gas is fed to the anode layer 208 from the anode inlet manifold (not shown) along a streamline substantially perpendicularly to the anode inlet stack face 212. The anode feed gas fed through partial anode inlet 216 is redirected with an anode inlet diverter (a diverting surface) 252 through the first extended edge seal chamber 236 and back into the anode active area 213 of the fuel cell assembly 211 into a stream substantially parallel with the flow of cathode feed gas and then into the second extended edge seal chamber 246 and then output through the partial anode outlet 218. It will be appreciated that a portion of the anode gas traveling through the active anode section is redirected with a first side of an anode outlet diverter (another diverting surface) 266 into the second extended edge seal chamber 246 and that the anode gas traveling through the second extended edge seal chamber 246 may be redirected with a second side of the anode outlet diverter 266 through the partial anode outlet 218.

In the above configuration, the anode exhaust is diverted into a streamline flowing substantially perpendicularly to the anode outlet stack face 214 of the fuel cell stack 200. As further shown in FIG. 3, the cathode inlet stack face 222 and the cathode outlet stack face 224 are substantially perpendicular to the anode inlet stack face 212 and the anode outlet stack face 214 of the fuel cell stack 200. In this configuration, the cathode feed gas is supplied to and the cathode exhaust is output from the cathode layer 210 along substantially parallel flow paths from each other. For example, the cathode feed gas flows along a streamline substantially perpendicularly to the cathode inlet stack face 222 and the cathode exhaust gas flows along a streamline substantially perpendicularly to the cathode outlet stack face 224. According to an exemplary embodiment, the flow of the cathode feed gas through the cathode layer 210, as it is reacted and converted into cathode exhaust, flows along a substantially linear streamline between the cathode inlet 226 and the cathode outlet 228.

Although the first and second extended edge seal chambers 236, 246 depicted in FIG. 3 have a trapezoidal footprint extending away from the anode active area bounded by one long sidewall, two shorter sidewalls, a top surface, and a bottom surface, it will be appreciated that the invention is not so limited. The first extended edge seal chamber 236 may have any dimension, or be any shape, that encloses a chamber capable of accepting anode process gas fed via partial anode inlet 216 and redirected by anode inlet diverter 252 and providing that anode process gas to the anode active area 213 through anode active area inlet 272. Similarly, the second extended edge seal chamber 246 may have any dimension, or be any shape, that encloses a chamber capable of accepting anode process gas fed via anode active area outlet 274 and providing that anode process gas through the partial anode outlet 218 (via redirection by anode outlet divert 266).

As shown in FIG. 3, the anode inlet diverter 252 extends at a non-perpendicular angle relative to each of the anode inlet side 212 and cathode inlet side 222 of the fuel cell stack 200. Also, as depicted in FIG. 3, the anode inlet diverter 252 extends in a straight, linear fashion from the anode inlet side 212 toward the cathode inlet side 222. However, the anode inlet diverter 252 may be curved (concave or convex) or any other shape, as long as it redirects anode process gas fed through partial anode inlet 216 into the first extended edge seal chamber 236. The anode inlet diverter 252 extends vertically along substantially an entire height of the anode layer 208, such that anode feed gas does not pass over or under the anode inlet diverter 252 into the rest of the anode layer 208.

Similarly, anode outlet diverter 266 extends at a non-perpendicular angle relative to each of the anode outlet side 214 and cathode outlet side 224 of the fuel cell stack 200. Although the anode inlet diverter 252 depicted in FIG. 3 extends in a straight, linear fashion from the anode outlet side 214 toward the cathode outlet side 224, the anode inlet diverter 252 may be curved (concave or convex) or any other shape, as long as it redirects anode process gas fed through second extended edge seal chamber 236 through the partial anode outlet 218. The anode outlet diverter 266 extends vertically along substantially an entire height of the anode layer 208, such that anode process gas does not pass over or under the anode outlet diverter 252.

Referring back to FIG. 2, it will be appreciated that as a process gas flows through a fuel cell, the composition of that gas will change as it travels across the fuel cell and is reacted with another process gas in the fuel cell. As such, the composition of the anode process gas flowing through fuel cell stack 10 (in FIG. 2) changes as it travels from the anode inlet side 16 to the anode outlet side 18 of the stack. However, the composition of the cathode process gas entering fuel cell stack 10 is uniformly distributed along the width of the cathode layer 14 (measured from the anode inlet side 16 to the anode outlet side 18 of the fuel cell stack 10). In contrast, during operation of the embodiment depicted in FIG. 3, the anode process gas enters the anode active area 213 through the active anode inlet 272 rather than an opening spanning the anode inlet side 212 of the fuel cell stack 200 (such as depicted in FIG. 2). As with fuel cell stack 10 (in FIG. 2), the cathode process gas enters the fuel cell stack 200 (at the cathode inlet side 222) in a substantially uniform flow distribution along the entire width of the cathode layer 210 (measured from the anode inlet side 212 to the anode outlet side 214 of the fuel cell stack 200). Thus, the composition of the anode process gas entering the anode active area 213 and the composition of the cathode process gas entering the cathode layer 210 are substantially uniform across the width of the fuel cell stack 200 (measured from the anode inlet side 212 to the anode outlet side 214 of the fuel cell stack 200). As will be discussed below, the uniform compositional distribution of the process gases entering the stack (along the width of the cathode inlet) in a substantially parallel fashion enables a more uniform distribution of current density across the cathode inlet span, instead of higher current densities proximate the anode inlet side 16 and cathode inlet side 20 of stack 10 (region I of FIG. 2) and lower current densities away from the inlets.

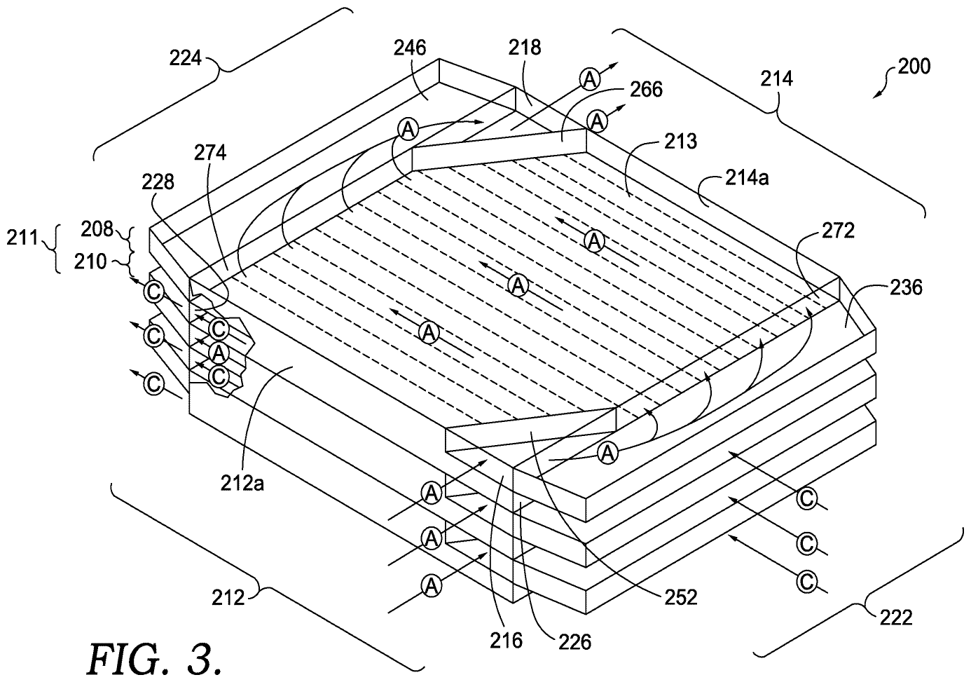

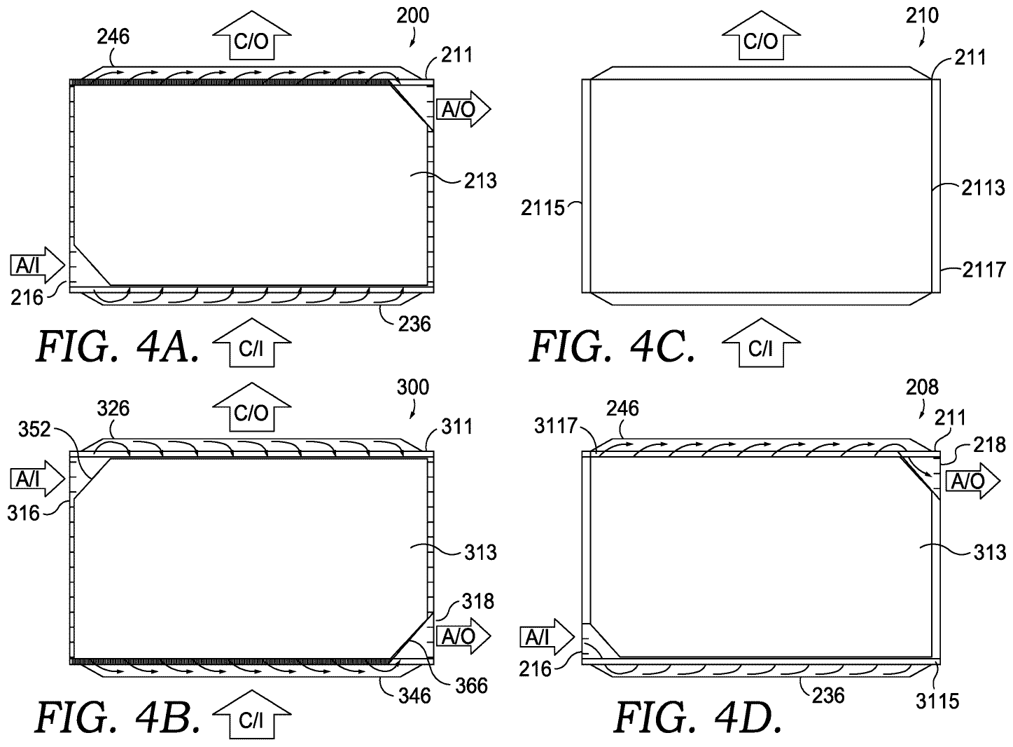

FIG. 4A is a top plan view of fuel cell stack 200 with the top surface of the anode layer 208 (of the topmost fuel cell assembly 211) removed to show (a) anode feed gas entering the anode active area 213 from a first extended edge seal chamber 236, and (b) anode exhaust entering the second extended edge seal chamber 246 from the anode active area 213. The flow of anode process gas across the anode active area (which enters as anode feed gas and exits as anode exhaust) in a substantially linear fashion parallel to the flow of cathode process gas through the cathode layer 210 of the fuel cell assembly 211. As noted above, this flow arrangement may be described as co-flow.

FIG. 4B depicts anode process gas flow through a fuel cell assembly in a counter-flow direction. FIG. 4B is a top plan view of fuel cell stack 300 with the top surface of the anode layer 308 (of the topmost fuel cell assembly 311) removed. Similar to fuel cell stack 200 and fuel cell assembly 211, the anode process gas enters fuel cell stack 300/fuel cell assembly 311 from an anode inlet side that is perpendicular to a side where cathode process gas enters and anode process gas exits a side opposite the anode inlet side and the cathode process gas exits a side opposite the cathode inlet side. The anode process gas enters the anode inlet side of fuel cell assembly 311 via a partial anode inlet 316, which is similar to the partial anode inlet 216 (for fuel cell assembly 211). However, partial anode inlet 316 is proximate a stack corner between the anode inlet side and the cathode outlet side of fuel cell stack 300. Whereas the partial anode inlet 216 (for fuel cell assembly 211) is proximate a stack corner between the anode inlet side and the cathode inlet side of fuel cell stack 200. After entering the fuel cell assembly 311, the anode process gas is redirected (by an anode inlet diverter 352) into a first extended edge seal chamber 326 (located on a cathode outlet side of fuel cell assembly 311) and redirected further into the anode active area 313. Reacted anode process gas exits the anode active area 313 and enters the second extended edge seal chamber 346 and is redirected toward anode outlet divert 366 and anode partial outlet 318. In this configuration, the anode process gas traverses the anode active area 313 in a direction substantially parallel to, but opposite of, the cathode process gas traversing thru the cathode layer of fuel cell assembly 311.

In either flow configuration (co-flow or counter-flow), the distribution of each of the anode feed gas and cathode feed gas is substantially uniform laterally across the fuel cell stack in the direction from the anode inlet side to the anode outlet side, providing a one-dimensional distribution of current density across the fuel cell stack (measured from cathode inlet to cathode outlet).

It will be appreciated that the co-flow configuration depicted in FIG. 4A and the counter-flow configuration depicted in FIG. 4B can utilize the same external manifold arrangements described herein with respect to fuel cell stack 10 (depicted in FIG. 2). Alternatively, a counter-flow configuration may be achieved with the embodiment of FIG. 4A by rearranging the direction of the anode process gas through the fuel cell stack (e.g., switching the anode inlet manifold with the anode outlet manifold) or by rearranging the direction of the cathode process gas through the fuel cell stack (e.g., switching the cathode inlet manifold with the cathode outlet manifold).

FIG. 4C is a top plan view of cathode layer 210 (of fuel cell assembly 211) with the cathode electrode removed to show cathode active area 2113. During operation, cathode process gas traverses cathode active area 2113 in a substantially linear path from the cathode inlet side to the cathode outlet side. First cathode edge seal 2115 prevents cathode process gas from entering the anode inlet side of fuel cell assembly 211, e.g., anode inlet manifold (not shown). Second cathode edge seal 2117 prevents cathode process gas from entering the anode outlet side of fuel cell assembly 211, e.g., anode outlet manifold (not shown).

FIG. 4D is a top plan view of anode layer 208 (of fuel cell assembly 211) with major portions of the top surface covering the anode active area 313 and the extended edge seal chambers 236, 246. During operation, as described in detail above, anode process gas enters first extended edge seal chamber 236 and traverses anode active area 313 in a substantially linear path from the cathode inlet side to the cathode outlet side (of fuel cell assembly 211). First anode edge seal 3115 prevents anode process gas from entering the cathode inlet side of the fuel cell assembly 211, e.g., cathode inlet manifold (not shown), as the anode process gas travels from partial anode inlet 216 to first extended edge seal chamber 236 and to anode active area 313. Second anode edge seal 3117 prevents anode process gas from entering the cathode outlet side of fuel cell assembly 211, e.g., cathode outlet manifold (not shown), as anode process gas travels from anode active area 313 to second extended edge seal chamber 246 and to anode partial outlet 218.

According to yet another exemplary embodiment, it should be understood that the cathode layer 210 may be configured in substantially the same way as and in place of the anode layer 208, such that an extended edge seal chamber associated with the cathode inlet (e.g., “cathode inlet chamber” or first extended edge seal chamber 236) is disposed on a stack side adjacent (and perpendicular) to the cathode inlet side 222 and configured to cooperate with an inlet diverter in the cathode layer 210 to redirect cathode feed gas therein to be substantially parallel with anode feed gas received directly at the anode inlet side 212 of the stack. Similarly, an extended edge seal chamber associated with the cathode outlet (e.g., “cathode outlet chamber” or second extended edge seal chamber 246) may be disposed on a stack side opposite the cathode inlet chamber and configured to cooperate with an outlet diverter in the cathode layer to redirect cathode exhaust from the fuel cell stack 200.

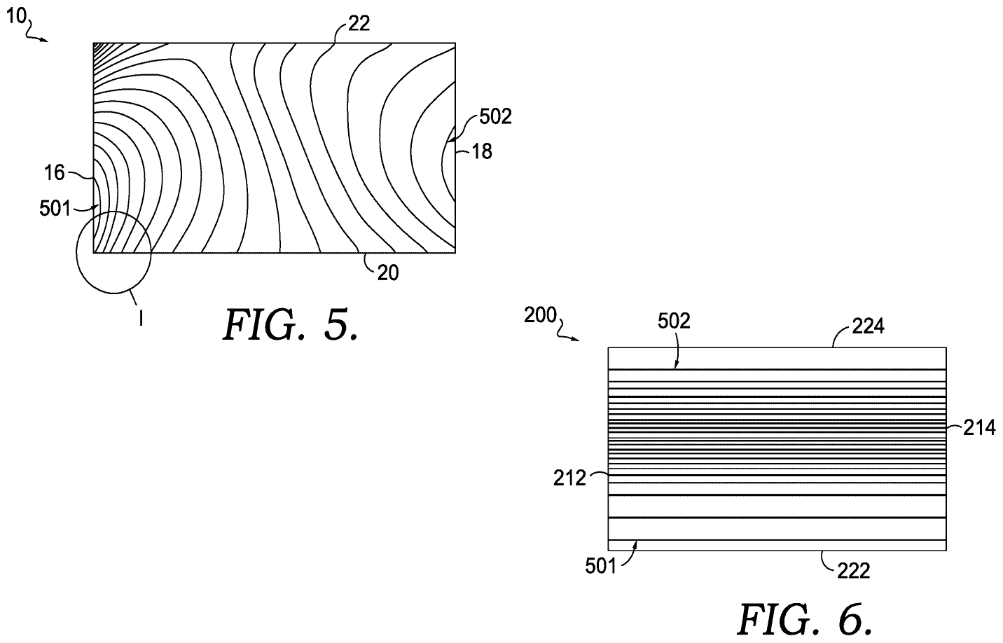

Referring now to FIG. 5, a representative distribution of current density on the conventional fuel cell stack 10 is shown, wherein isometric lines show contours of current density of the same value. Isometric line 501 represents the highest current density value and isometric line 502 represents the lowest current density value. It will be appreciated that intervening isometric lines between 501 and 502 represent intermediate current density values at regular intervals. In this configuration, the current has the highest density along the anode inlet side 16 proximate the corner where the anode inlet side 16 contacts the cathode inlet side 20 (region I). The current density drops non-linearly in the direction from the anode inlet side 16 to the anode outlet side 18. The current density also drops non-linearly in the direction from the cathode inlet side 20 to the cathode outlet side 22. The distribution of current density in each of these two directions provides for a two-dimensional current distribution, which makes the fuel cell stack 10 difficult to optimize. Notably, even if a large portion of the fuel cell stack 10 is able to be optimized to linearize current distribution, the corner where the anode inlet side 16 contacts the cathode outlet side 22 experiences a significant and sudden current drop, which may disrupt the performance of the fuel cell stack 10.

Referring now to FIG. 6, a distribution of current density in the fuel cell stack 200 is shown according to an exemplary embodiment, wherein isometric lines show contours of current density of the same value. Similar to FIG. 5, isometric line 501 represents the highest current density value and isometric line 502 represents the lowest current density value. It will be appreciated that intervening isometric lines between 501 and 502 represent intermediate current density values at regular intervals. This configuration may show the current density when both the anode feed gas and the cathode feed gas flow in the fuel cell stack 200 from the cathode inlet side 222 toward the cathode outlet side 224. The substantially parallel flows of the anode feed gas and the cathode feed gas provide for a substantially constant current density measured in a lateral direction perpendicular to the flow direction. For example, the current density at any given point in the fuel cell stack 200 may be substantially the same moving in a direction from the anode inlet side 212 directly toward the anode outlet side 214.

The CFD models depicted in FIGS. 5 and 6 are representative of current density profiles of a typical fuel cell within a conventional fuel cell stack 10 and a fuel cell stack 200 according to an exemplary embodiment, wherein both stacks are operated under similar total thermal gradients across the cell. Pictorially, it will be appreciated that fuel cell stack 200 has a more uniform and predictable current gradient across the cell. In addition, fuel cell stack 200 is predicted to be able to produce an overall higher total current than convention fuel cell stack 10 when operated at a similar total thermal gradient across the fuel cells. This is possible because fuel cell stack 200 provides a long leading-edge interface common to both the highest concentration cathode and anode gasses, resulting in larger areas of high current density (proximate cathode inlet side 222, see 501 in FIG. 6) compared to a single corner location in conventional fuel cell stack 10 where both reactants are at their highest concentration (region I, see 501 in FIG. 5). Specifically, the highest current density may be established at a location where the anode feed gas and the cathode feed gas are first introduced on opposing sides of the electrolyte matrix and the current density declines as feed gas is reacted and converted into exhaust. The substantially parallel flow paths for the anode feed gas and cathode feed gas, which form a one-dimensional distribution of current density increases the surface area in the fuel cell stack 200 in which the anode feed gas and the cathode feed gas first react, since in the fuel cell stack 200, the feed gases react across substantially the entire length of the cathode inlet side 222 of the fuel cell stack 200, rather than just at a corner.

### ADDITIONAL EMBODIMENTS

Embodiment 1. A fuel cell comprising: an anode configured to receive, and allow to pass through, an anode process gas, a cathode configured to receive, and allow to pass through, a cathode process gas, an electrolyte matrix layer separating the anode and the cathode, wherein one of the anode or the cathode has an extended edge seal chamber, wherein the fuel cell is configured to receive the anode process gas and the cathode process gas in substantially perpendicular directions relative to each other, and wherein the extended edge seal chamber is configured to allow the anode process gas and the cathode process gas to pass through the anode and the cathode in substantially parallel flow paths.

Embodiment 2. A fuel cell stack comprising: a fuel cell comprising: a first layer having an active area configured to receive and output a first process gas, a second layer configured to receive and output a second process gas, and an electrolyte matrix layer separating the first layer and the second layer, wherein the first layer includes an extended edge seal chamber extending away from the active area on a first side of the fuel cell, wherein the extended edge seal chamber is configured to receive the first process gas provided to the fuel cell stack in a first direction relative to the fuel cell stack and output the first process gas to the active area in a second direction substantially perpendicular to the first direction, and wherein the active area is configured to allow the first process gas to react with the second process gas.

Embodiment 3. The fuel cell stack of embodiment 2, wherein the second layer is configured to receive and output the second process gas in a direction substantially parallel to the second direction.

Embodiment 4. The fuel cell stack of embodiment 2 or 3, wherein the first layer includes a diverting surface configured to receive the first process gas and divert the first process gas into the extended edge seal chamber.

Embodiment 5. A fuel cell used in a fuel cell stack comprising: the fuel cell comprises an anode layer having an active anode area configured to receive and output anode process gas, a cathode layer configured to receive and output cathode process gas, and an electrolyte matrix layer separating the anode layer and the cathode layer, wherein the anode layer includes a first extended edge seal chamber extending away from the active anode area on a first side of the fuel cell, wherein the first extended edge seal chamber is configured to receive anode process gas provided to the fuel cell stack in a first direction relative to the fuel cell stack and output the anode process gas to the active anode area in a second direction substantially perpendicular to the first direction, and wherein the anode active area is configured to allow the anode process gas to react with the cathode process gas.

Embodiment 6. The fuel cell of embodiment 5, wherein the fuel cell further comprises: a second extended edge seal chamber extending away from the active anode area on a side opposite the first side of the fuel cell, wherein the second extended edge seal chamber is configured to receive the anode process gas in the second direction and divert the anode process gas in the first direction relative to the fuel cell stack.

Embodiment 7. The fuel cell of embodiment 5 or 6, wherein the cathode layer is configured to receive the cathode process gas in a direction substantially parallel to the second direction.

Embodiment 8. The fuel cell of any of embodiments 5-7, wherein the cathode layer is configured to output the cathode process gas in a direction substantially parallel to the second direction.

Embodiment 9. The fuel cell of any of embodiments 5-8, wherein the anode layer includes a first diverting surface configured to receive the anode process gas in the first direction and redirect the anode process gas toward the first extended edge seal chamber.

Embodiment 10. The fuel cell of any of embodiments 5-9, wherein the anode layer includes a second diverting surface configured to receive the anode process gas from the second extended edge seal chamber and redirect the anode process gas in the first direction.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, dimensions, structures, shapes and proportions of the various elements, values of parameters, mounting arrangements, use of materials, colors, orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A fuel cell assembly, comprising:
a first electrode comprising a first electrode inlet on a first side of the fuel cell assembly, a first electrode outlet on a second side of the fuel cell assembly, and a first electrode active area between the first electrode inlet and the first electrode outlet, wherein the first side and the second side are opposite sides of the fuel cell assembly;
a second electrode comprising a second electrode inlet on a third side of the fuel cell assembly, a second electrode active area including a second electrode active area inlet on the first side of the fuel cell assembly and a second electrode active area outlet on the second side of the fuel cell assembly, and an edge seal chamber on the first side of the fuel cell assembly adjacent to and outside of the second electrode active area, the edge seal chamber in fluid communication with the second electrode inlet and the second electrode active area inlet; and
an electrolyte matrix layer separating the second electrode and the first electrode.

2. The fuel cell assembly of claim 1, wherein the first electrode is configured to allow first electrode process gas to flow across the first electrode active area from the first electrode inlet to the first electrode outlet in a first direction, and the edge seal chamber is configured to allow second electrode process gas received by the second electrode inlet to flow across the second electrode active area from the second electrode active area inlet to the second electrode active area outlet in a second direction substantially parallel to the first direction.

3. The fuel cell assembly of claim 1, wherein (a) the first electrode is an anode and the second electrode is a cathode or (b) the first electrode is a cathode and the second electrode is an anode.

4. The fuel cell assembly of claim 1, wherein the second electrode further comprises a diverter surface separating the second electrode inlet from the second electrode active area.

5. The fuel cell assembly of claim 4, wherein the diverter surface is configured to cause second electrode process gas received at the second electrode inlet to flow into the edge seal chamber before flowing over the second electrode active area.

6. The fuel cell assembly of claim 4, wherein the diverter surface extends a non-perpendicular angle relative to the first side of the fuel cell assembly and the third side of the fuel cell assembly.

7. The fuel cell assembly of claim 1, wherein the second electrode further comprises an outlet edge seal chamber on the second side of the fuel cell assembly adjacent to and outside of the second electrode active area the edge seal chamber in fluid communication with the second electrode active area outlet and a second electrode outlet.

8. The fuel cell assembly of claim 7, wherein the second electrode outlet is on a fourth side of the fuel cell assembly opposite the third side of the fuel cell assembly.

9. The fuel cell assembly of claim 8, wherein the second electrode further comprises an outlet diverter surface separating the second electrode outlet from the second electrode active area.

10. The fuel cell assembly of claim 9, wherein the outlet diverter surface is configured to cause second electrode process gas flowing over the second electrode active area to flow into the edge seal chamber before flowing out of the second electrode outlet.

11. A fuel cell assembly, comprising:
a first electrode comprising a first electrode inlet on a first side of the fuel cell assembly, a first electrode outlet on a second side of the fuel cell assembly, and a first electrode active area between the first electrode inlet and the first electrode outlet, wherein the first side and the second side are opposite sides of the fuel cell assembly;
a second electrode comprising a second electrode inlet on a third side of the fuel cell assembly, a second electrode active area including a second electrode active area inlet on the second side of the fuel cell assembly and a second electrode active area outlet on the first side of the fuel cell assembly, and an edge seal chamber on the second side of the fuel cell assembly adjacent to and outside of the second electrode active area, the edge seal chamber in fluid communication with the second electrode inlet and the second electrode active area inlet; and
an electrolyte matrix layer separating the second electrode and the first electrode.

12. The fuel cell assembly of claim 11, wherein the first electrode is configured to allow first electrode process gas to flow across the first electrode active area from the first electrode inlet to the first electrode outlet in a first direction, and the edge seal chamber is configured to allow second electrode process gas received by the second electrode inlet to flow across the second electrode active area from the second electrode active area inlet to the second electrode active area outlet in a second direction substantially parallel to and opposite the first direction.

13. The fuel cell assembly of claim 11, wherein (a) the first electrode is an anode and the second electrode is a cathode or (b) the first electrode is a cathode and the second electrode is an anode.

14. The fuel cell assembly of claim 11, wherein the second electrode further comprises a diverter surface separating the second electrode inlet from the second electrode active area, the diverter surface configured to cause second electrode process gas received at the second electrode inlet to flow into the edge seal chamber before flowing over the second electrode active area.

15. The fuel cell assembly of claim 11, wherein the second electrode further comprises an outlet edge seal chamber on the first side of the fuel cell assembly adjacent to and outside of the second electrode active area the edge seal chamber in fluid communication with the second electrode active area outlet and a second electrode outlet on a fourth side of the fuel cell assembly opposite the third side of the fuel cell assembly.

16. The fuel cell assembly of claim 15, wherein the second electrode further comprises an outlet diverter surface separating the second electrode outlet from the second electrode active area, wherein the outlet diverter surface is configured to cause second electrode process gas flowing over the second electrode active area to flow into the edge seal chamber before flowing out of the second electrode outlet.

17. A fuel cell stack comprising:
a plurality of stacked fuel cell assemblies separated from each other by a bipolar plate, each fuel cell assembly comprising:
a first electrode comprising a first electrode inlet on a first side of the fuel cell stack, a first electrode outlet on a second side of the fuel cell stack, and a first electrode active area between the first electrode inlet and the first electrode outlet, wherein the first side and the second side are opposite sides of the fuel cell stack;
a second electrode comprising:
a second electrode inlet on a third side of the fuel cell stack,
a second electrode outlet on a fourth side of the fuel cell stack, wherein the third side and the fourth side are opposite sides of the fuel cell stack,
a second electrode active area including a second electrode active area inlet on one of the first side or the second side of the fuel cell stack and a second electrode active area outlet on the other of the first side or the second side of the fuel cell stack,
a first edge seal chamber adjacent to and outside of the second electrode active area, the first edge seal chamber in fluid communication with the second electrode inlet and the second electrode active area inlet; and
a second edge seal chamber adjacent to and outside of the second electrode active area, the first edge seal chamber in fluid communication with the second electrode inlet and the second electrode active area inlet; and
an electrolyte matrix layer separating the second electrode and the first electrode;
a first electrode inlet manifold configured to supply first electrode process gas to the first side of the fuel cell stack; and
a second electrode inlet manifold configured to supply second electrode process gas to the third side of the fuel cell stack.

18. The fuel cell stack of claim 17, wherein each fuel cell assembly further includes a partial seal on the third side of the fuel cell stack separating the second electrode active area from the second electrode inlet manifold and a second electrode inlet diverter separating the second electrode inlet from the second electrode active area.

19. The fuel cell stack of claim 18, wherein each diverter extends from a second electrode cell surface to an adjacent bipolar plate.

20. The fuel cell stack of claim 18, wherein the partial seals and the diverters are configured to cause the second electrode process gas to flow through the second electrode inlets into the first edge seal chambers before flowing over the second electrode active areas.
